(19) United States
(12) Patent Application Publication
(10) Pub. No.: US 2004/0238733 A1
(43) Pub. Date: Dec. 2, 2004

(54) Atomic reflection optical element

(76) Inventor: Junichi Fujita, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/473,301

(22) PCT Filed: Mar. 29, 2002
(86) PCT No.: PCT/JP02/03196

(30) Foreign Application Priority Data
Mar. 30, 2001 (JP) 2001-100825

(51) Int. Cl. H01S 3/00; H01S 1/00; H05H 3/02

(52) U.S. Cl. 250/251

(57) ABSTRACT

An atomic reflection optical element for an atomic wave (de Broglie wave) so constituted as to increase the reflectance of an atomic wave by reducing the apparent atomic density of reflection plane; for example, a porous surface structure, a structure supporting a very thin film, or a structure in which the insular portion (reflection surface) of a reflection-diffraction grating is narrowed is used for this purpose. The above arrangement can provide an atomic reflection optical element having a high atomic wave coherent reflection power.

### TECHNICAL FIELD

The present invention relates to an atomic reflection optical element, and more specifically, it relates to an atomic reflection optical element for operating coherent atoms.

### BACKGROUND ART

In recent years, the development of the laser cooling technique has made the wave nature of atoms visible in actuality. The de Broglie wavelength of laser-cooled cryogenic atoms is on the order of angstrom, and is long such an extent as to get close to the wavelength of visible light. Therefore, using laser-cooled/trapped cryogenic atoms as a beam source allows atoms to be holographically operated. This type of atomic beam holography is treated in, e.g., “Nature 1996, Vol. 380, No. 6576, pp. 691-694”, in which this type of atomic beam holography is expected to provide a possible ultimate resolution and to allow its application to an ultrafine processing technique at a level at which atoms can be operated. Furthermore, the application technique of cooled atoms to an industry using atomic beams has become very important. For example, this application technique has allowed the Bose-Einstein condensation of dilute atoms to be realized, and enabled an atomic laser to be demonstrated.

Also, use of such cooled atoms allows the accuracy of an atomic clock or atomic interferometer using the resonance of atoms to be dramatically improved. Employment of a gravity meter using a high-accuracy atomic interferometer makes it possible to locate the position of an oil field or mineral deposit with high accuracy by remote sensing from ground or from the sky over. Moreover, use of the gravity meter allows detection of the gravity wave, and an absolute measurement of the universal gravity G. Thus, such techniques using cooled atoms are expected to find their application over a wide range of fields from the verification of the fundamental physical constants in the geophysics, astrophysics and the like, the formulation of theories back to the foundations of physical theories, to the aerospace engineering and next-generation electronics such as a quantum operation computer.

One example of a key device of an optical system for treating such coherent atoms is a reflection interference device. However, in reality, the reflection interference device has involved many problems to be solved. That is, the process in which atoms, i.e., bodies each having a high particulate nature are reflected from a reflection surface, is a so-called non-elastic scattering process of rigid bodies. In this process, an energy loss occurs, and the coherence disappears.

However, according to an investigation by the present inventors, it was found that, under a certain condition, coherent reflection in which the nature and phase as a wave, of atoms are retained, takes place. As a result of our further investigation performed on the basis of the above findings, we found that, on the condition that coherent reflection of an atomic wave (de Broglie wave) is provided, its reflection power can be strengthened.

The object of the present invention is to provide, based on the above-described findings, an atomic reflection optical element capable of reflecting coherent light while reducing the energy loss during reflection.

The specific object of the present invention is to provide an atomic reflection optical element such that, on the condition that coherent reflection of an atomic wave (de Broglie wave) is provided, its reflection power is strengthened.

### DISCLOSURE OF INVENTION

Specifically, the present invention provides an atomic reflection optical element described below.

According to a first aspect of the present invention, there is provided an atomic reflection optical element including a reflection portion for reflecting incident atoms, wherein the reflection portion has a reflection base layer and a reflection surface layer disposed on the atom incident side of the reflection base layer, and wherein the reflection surface layer has an atomic density effectively lower than that of the reflection base layer.

According to a second aspect of the present invention, there is provided an atomic reflection optical element wherein, in the first aspect, the main direction for defining the atomic density is the normal direction on the surface at a point where atoms are made incident and reflected.

According to a third aspect of the present invention, there is provided an atomic reflection optical element including a reflection portion for reflecting incident atoms, wherein the reflection portion has a reflection base layer and a reflection surface layer disposed on the atom incident side of the reflection base layer, and wherein the reflection surface layer has a molecular density effectively lower than that of the reflection base layer.

According to a fourth aspect of the present invention, there is provided an atomic reflection optical element wherein, in the third aspect, the main direction for defining the molecular density is the normal direction on the surface at a point where atoms are made incident and reflected.

According to a fifth aspect of the present invention, there is provided an atomic reflection optical element wherein, in any one of the first to fourth aspects, the reflection surface layer has a porous portion.

According to a sixth aspect of the present invention, there is provided an atomic reflection optical element wherein, in the fifth aspect, the size of each pore in the porous portion is smaller than the dimension of the perpendicular component of the de Broglie wavelength (atomic wavelength: λ) of incident atoms with respect to the reflection surface.

According to a seventh aspect of the present invention, there is provided an atomic reflection optical element wherein, in the firth or sixth aspect, the reflection surface layer comprises a porous silicon film, and wherein, in the firth or sixth aspect, the reflection base layer comprises a silicon layer.

According to an eighth aspect of the present invention, there is provided an atomic reflection optical element wherein, in any one of the first to fourth aspects, the reflection surface layer has a structure in which a thin film is supported on the reflection base layer by pillars.

According to a ninth aspect of the present invention, there is provided an atomic reflection optical element wherein, in the eighth aspect, the thin film comprises a silicon nitride film.

According to a tenth aspect of the present invention, there is provided an atomic reflection optical element wherein, in any one of the first to fourth aspects, the reflection portion has a grating structure in which the reflection surface layer has a plurality of insular portions and groove portions formed on the reflection base layer.

According to an eleventh aspect of the present invention, there is provided an atomic reflection optical element wherein, in the tenth aspect, the grating structure is configured so that, with respect to the grating period L thereof, the width W of each of the insular portions substantially satisfies the condition: L/10000≦W≦L/2.

According to a twelfth aspect of the present invention, there is provided an atomic reflection optical element wherein, in the tenth or eleventh aspect, the depth of each of the groove portions is selected so that the phase difference between the atomic reflection from the surface of each of the insular portions and that from the bottom of each of the groove portions becomes larger than the de Broglie wavelength of incident atoms.

According to a thirteenth aspect of the present invention, there is provided an atomic reflection optical element wherein, in any one of the first to one hundred and twenty-fourth aspects, the grating structure is configured so that a plurality of insular portions are formed in one grating period.

According to a fourteenth aspect of the present invention, there is provided an atomic reflection optical element wherein, in any one of the first to thirteenth aspects, each of the insular portions in the reflection surface layer and the reflection base portion comprise silicon.

According to a fifteenth aspect of the present invention, there is provided an atomic reflection optical element wherein, in any one of the first to fourteenth aspects, the reflection portion has a curved surface structure.

According to a sixteenth aspect of the present invention, there is provided a holographic atomic reflection optical element having the atomic reflection optical element according to any one of the first to fifteenth aspects, as a reflection pixel.

With these features, on the reflection surface of the atomic reflection optical element, at a place at a depth on the order of atomic wavelength, the atomic wave undergoes an increase in the impedance mismatch, or in the level difference in the refractive index. As a result, the atomic reflection optical element according to the present invention has a stronger atomic coherent reflection power than that of the conventional art.

Prior to specific descriptions using drawings, of the atomic reflection optical element according to embodiments of the present invention, the principle and concept of the present invention will be explained.

When approaching the surface of a solid, atoms are generally subjected to an attraction by van der Waals' force. After having collided against the surface of the solid, the atoms are adsorbed thereon or scattered. However, for laser-cooled cryogenic atoms, the potential due to the van der Waals' force, which potential contributes with a parameter 1/r³, is sufficiently steep, and this steep change in the potential causes an impedance mismatch with respect to the atomic wave. As a consequence, the atomic wave reflects before the atoms collide against or scatter on the surface of the solid. In other words, quantum reflection of the atoms occurs on the surface of the solid. The atomic speed at which the reflection of the atoms occur on the solid surface, is on the order of several millimeters/sec to several tens of millimeters/sec in terms of the speed in the direction perpendicular to the surface. Because the speed of an atomic group that has made Bose condensation is on the above-described order, it is also possible to use a solid as an coherent atomic reflection optical element for such an atomic group. Moreover, even in the case of thermal atoms (i.e., thermally excited atoms), when thinking of total reflection with an incident angle small, and supposing that the speed thereof is 2 m/sec (given a gravitational fall, this value corresponds to a fall of approximately 40 cm), total reflection on the order of several tens milliradians in terms of an incident angle would occur. Such quantum reflection has been theoretically anticipated (C. Henkel, C. I. Westbrook, A. Aspect Quantum reflection: atomic matter wave optics in an attractive exponential potential J. Opt. Soc. Am. B13, 233-243 (1996)), and has been observed on the surface of a superfluiditive helium.

Because the reflection of an atomic wave is reflection due to an impedance mismatch, or a level difference in the refractive index, the reflectance is determined by the magnitude of this level difference. The position (the distance from the solid surface) where the level difference becomes a maximum, changes with the magnitude of the normal speed and/or of the reflection coefficient C of atoms. In order to determine the reflectance, it is necessary to determine the magnitude of the level difference at the position where the level difference becomes the maximum.

By rough estimate, the maximum value of the level difference is substantially proportional to C^{-1/2}. Because the reflection coefficient C is proportional to the density of atoms (or molecule) constituting a solid, it is possible to form a mirror having a very high reflectance by constituting the portion up to the position at a distance of several microns from the surface, using a solid having a very low density. Here, the main direction for defining the atomic density (or the molecular density) is the normal direction on the surface at a point where atoms are made incident and reflected.

In order to implement an atomic reflecting mirror based on such a principle, it is recommendable to constitute the reflection surface layer on the side onto which atoms are made incident, using, e.g., a porous material. The size of each pore in the porous material is advisable to be smaller than the order on the wavelength of an atomic wave. Specifically, because the atomic wave of atoms subjected to Bose-Einstein condensation (BEC) has a wavelength of several micrometers, a porous material with a pore size of several hundreds nanometers, for example, a Si plate of which the surface is processed into a porous silicon, or a Si substrate in which micropores are formed with a random or periodic configuration serves as an atomic reflecting mirror (specifically, the reflection surface layer in the reflection portion).

It is also possible to support a very thin film, for example, a film of silicon carbide or silicon nitride by suitable pillars, thereby constituting an atomic reflection optical element using the above-described thin film as a reflection surface layer.

The above-described design guideline for an atomic reflection optical element can also be applied to a reflection type diffraction grating. Suppose that atoms are made incident onto on uniform solid surface and grating with a small incident angle. Because the atoms do not geometrically hit the bottoms of groove portions of the grating, it is considered that the reflectance is lower on the diffraction grating than on the flat solid surface. However, if the incident angle is small and the atoms see an average surface, the conclusion would be different. That is, in a diffraction grating, if the width of each groove portion and the width (crest width) of each insular portion (reflection surface) are equal, and the groove portion is enough deep for the incident atoms not to perceive the potential from the bottom of the groove portion, the effective potential coefficient C decreases to half what it is in the case of the mirror reflection from a uniform surface, thereby increasing the reflectance. Likewise, if the crest width is one ninth a grating pitch, the average density falls to one ninth of what it is in the case of the mirror reflection from a uniform surface, thereby increasing the reflectance by a factor of three.

As is evident from the foregoing, in a reflection type diffraction grating in which the reflection surface layer and reflection base layer in the reflection portion are formed of the same material (for example, Si), narrowing the width of each insular portion (reflection surface) allows the reflectance to be increased. Namely, by reducing the area (unit area in the reflection direction) of the insular portion (reflection surface), the effective reflection coefficient C can be decreased, thereby providing a high reflection peak power.

However, considering the coherent atomic reflection, it is desirable that the width W of each insular portion be not less than 1/10000 the grating period L. That the width W of each insular portion is less than 1/10000 the grating period L means that the width W of each insular portion is substantially on the same order as that of the wavelength of an atomic wave, and implies that no coherent reflection takes place. It is desirable that the depth of each groove portion be selected so that the phase difference between the reflection from the insular portion (reflection portion) and that from the bottom of the groove portion is not less than 1 λ. The depth of the groove portion needs to be set to an extent such that incident atoms do not perceive a Casimir force with respect to the atomic reflection surface. Furthermore, it is desirable that the depth of the groove portion be selected so that the phase difference between the reflecting atoms from the bottom of the groove portion and that from the insular portion (reflection portion) is at least 2π.

The following modification is also feasible. As described above, in principle, it is essential only that the effective C of the potential −C/rⁿ concerned with the reflection be reduced. From this viewpoint, a method by which the reflection surface width of the grating in one period is simply reduced, and a method by which the area of the reflection surface is reduced or the reflection surface is divided into some pieces, would be usable. This principle is not limited to the grating, but is likewise applicable to, for example, the shape of a reflection pixel constituting an atomic reflection hologram. In this case, in order to increase the reflection power of the hologram, it is advisable to reduce the size of each pixel in the reflection direction with respect to pixels forming a periodical array, or divide and reduce each pixel into a plurality of rectangular shapes, whereby the effective reflection coefficient C is reduced. However, if the insular portion (reflection surface) is made too small as seen from incident atoms, it cannot be regarded as an average reflection surface, resulting in a decrease in the reflection power. To prevent such a decrease in the reflection power, it is recommended that a group of insular portions be arranged to an extent such that they can be regarded as an average reflection surface while reducing the width of each individual insular portion (i.e., reflection surface width).

Meanwhile, the above-described surface of the atomic reflection optical element is not restricted to a plane, but may be a curved surface. In other words, the surface of the atomic reflection optical element may be a concave or convex surface with a curvature.

The above-described concept of the atomic reflection optical element is likewise applicable to a holographic atomic reflection optical element. Specifically, the holographic atomic reflection optical element can be implemented by dividing each of the pixels constituting the reflection surface into gratings, and reducing the effective atomic density of the surface of each of the pixels. Here, as a method for reducing the atomic density,.the one in the above-described atomic reflection optical element can be applied. Such a feature allows the brightness of the atomic reflection hologram to be enhanced.

### BRIEF DESCRIPTION OF THE DRAWINGS

FIG. 1 is a sectional view of an example of an atomic reflection optical element according to a first embodiment of the present invention.

FIG. 2 is a sectional view of an example of an atomic reflection optical element according to a second embodiment of the present invention.

FIG. 3 is a sectional view of an example of an atomic reflection optical element according to a third embodiment of the present invention.

FIG. 4 is a sectional view of another example of an atomic reflection optical element according to a third embodiment of the present invention.

FIG. 5 is a graph showing reflection powers measured for examining the effect of the atomic reflection optical element according to a third embodiment of the present invention.

FIG. 6 is a sectional view of a modification of the atomic reflection optical element according to the third embodiment of the present invention.

FIG. 7 is a sectional view of a modification of the atomic reflection optical element according to the first embodiment of the present invention.

FIG. 8 is a sectional view of another modification of the atomic reflection optical element according to the third embodiment of the present invention.

FIG. 9 is a representation of a reflection atomic beam hologram incorporating the concept of the present invention.

### BEST MODE FOR CARRYING OUT THE INVENTION

### FIRST EMBODIMENT

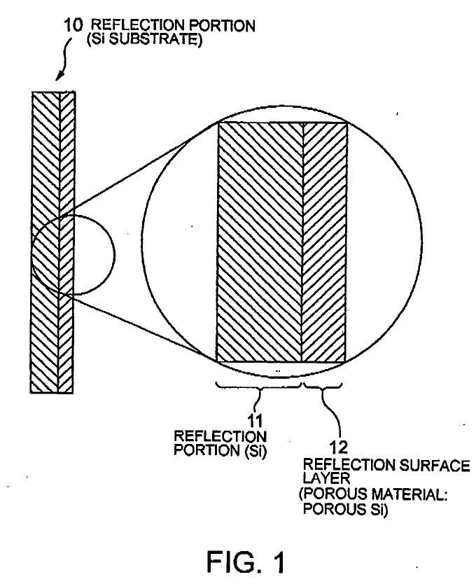

An atomic reflection optical element according to a first embodiment of the present invention has a reflection portion 10 having a sectional structure shown in FIG. 1. The reflection portion 10 includes a reflection base layer 11, and a reflection surface layer 12 disposed on the atom incident side of the reflection base layer 11. As described above, a high reflectance can be obtained by making lower the average atomic density of a surface on which atoms are made incident, i.e., that of the reflection surface layer 12 than that in the conventional art. To achieve a low level of an average atomic density on the reflection surface, in the atomic reflection optical element according to this embodiment, the reflection surface layer 12 is made of a porous material.

Here, the surface of the porous layer does not necessarily require to be flat on the atomic level. The surface of the porous layer has only to have a flatness on the level of the wavelength of an atomic wave to be reflected, i.e., de Broglie wavelength.

To examine the effect of this embodiment, a Si substrate was used as the reflection portion (substrate) of the atomic reflection optical element, and the surface thereof is treated, so that a porous layer (reflection surface layer 12) was formed on the surface. In this embodiment, out of the Si substrate serving as a material of the reflection portion 10, the portion that is not subjected to porosification is the reflection base layer 11. With regard to the surface treating, specifically, anodic oxidation was performed in a mixed solution of hydrofluoric acid and ethanol, using platinum opposite electrodes. As a result, a porous layer having a thickness of approximately 10 micrometers was obtained. Use of the atomic reflection optical element formed in this manner allowed Rb atoms subjected to Bose-Einstein condensation (BEC) to be quantum-reflected. The Rb atoms pushed out by a photon pressure was made incident substantially perpendicularly onto the reflection surface at a speed of approximately 3 mm/sec, and a reflectance of approximately 50% was obtained.

### SECOND EMBODIMENT

An atomic reflection optical element according to a second embodiment of the present invention is one that uses a very thin film, e.g., a silicon carbide (SiC) thin film or a silicon nitride (Si₃N₄) thin film, as a structure of the reflection surface. Herein, because it is difficult to hold such a very thin film in a state of a large area, pillars may be provided at appropriate positions for holding the thin film.

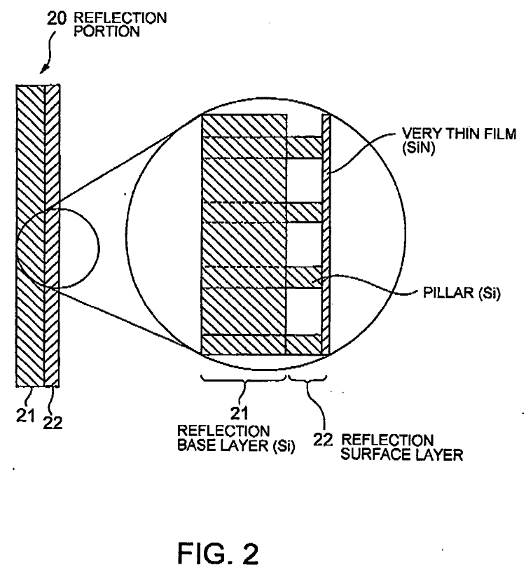

FIG. 2 shows an example of such an atomic reflection optical element. One portion of the substrate of the atomic reflection optical element constitutes a reflection portion 20. An enlarged view of the one portion is depicted in a circle on the right side of FIG. 2. Referring to this enlarged view, a reflection surface layer 22 is configured so that a very thin film is supported on a reflection base layer 21 by pillars. Specifically, in the example illustrated in FIG. 2, a SiN film with a thickness of 100 nm is formed on a Si substrate by CVD, and thereafter, a membrane is used that was obtained by back-etching Si from behind the Si substrate. Also, in the illustrated example, pillars each having a width of 10 micrometers are provided at pitches of 100 micrometers. By the measured results of the reflectance with this very thin film, it was confirmed that a reflectance on the same order as that of the atomic reflection optical element (the one using porous silicon) according to the first embodiment can be obtained, as a reflectance with respect to a Rb atomic wave subjected to cryogenic Bose-Einstein condensation (BEC).

### THIRD EMBODIMENT

An atomic reflection optical element according to a third embodiment of the present invention is one obtained by applying the concept of the present invention to a reflection type grating.

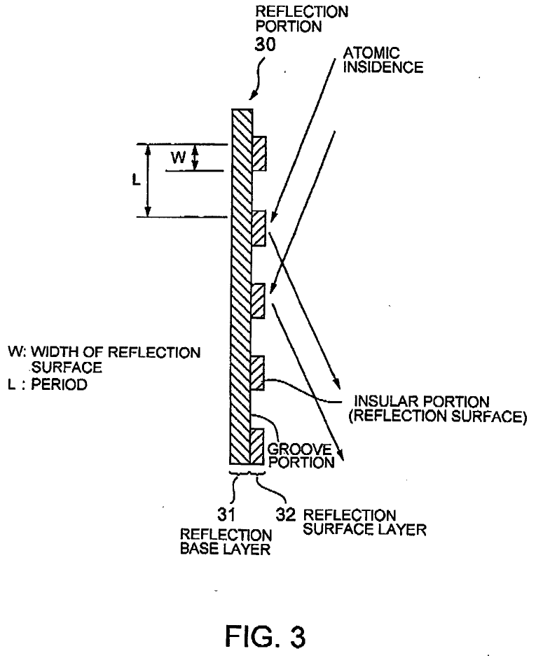

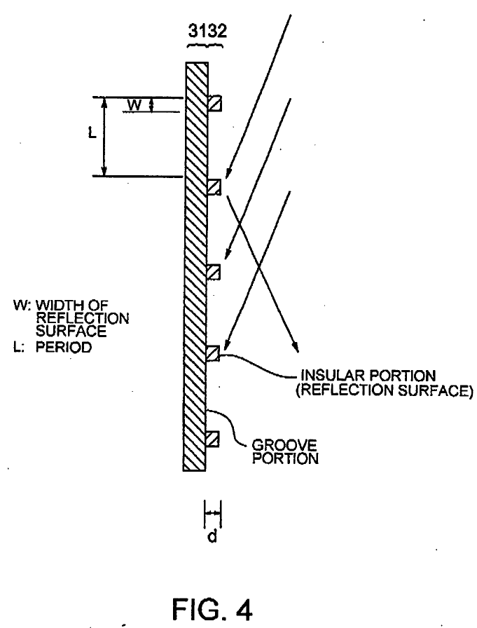

Referring to FIG. 3, a reflection portion 30 of the atomic reflection optical element according to the third embodiment has a grating structure comprising a plurality of insular portions (reflection surfaces) and groove portions formed on the surface of a reflection base layer 31. The reflection from the grating is reflection based on total reflection up to a critical temperature, whereas over the critical temperature, reflection occurs at an angle θ that is given by an expression: sin θ=nλ/L, where λ denotes a de Broglie wavelength. The reflection power of the atomic wave with respect to such a grating also depends upon an atomic density on the reflection surface, which is the basic principle of the present invention. That is, the average atomic density on the surface is lower and the reflection power is high in the grating structure in which the ratio of the width of the groove portion in the reflection surface layer 32 to the width of the insular portion (reflection surface) thereon is over 1 as shown in FIG. 4, than in the grating structure in which the ratio between the width of the insular portion and the width of the groove portion is 1:1. If there is provided a structure in which the ratio between the width of the insular portion and that of the groove portion is 1:9, a reflection power becomes approximately triple that of the structure in which the ratio between the width of the insular portion and that of the groove portion is 1:1, can be obtained. If the ratio between the width of the insular portion and that of the groove portion is configured to be 1:100, a reflection power approximately ten times that in the structure in which the ratio between the width of the insular portion and that of the groove portion is 1:1, can be obtained.

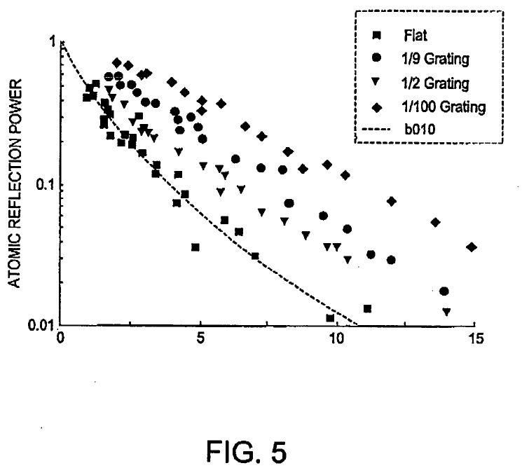

FIG. 5 shows the results of the reflectance measured based on the above-described findings. The graph in FIG. 5 shows atomic reflection powers when measured under the condition of free fall, using Ne atoms of approximately 50 μK, as atoms. The horizontal axis of the illustrated graph denotes the speed in the direction perpendicular to the reflection surface. Here, the incident angle θ of an atom is given by the expression: tan θ=(the speed in the normal direction (horizontal axis))/(the speed in the parallel direction with the reflection surface). In the illustrated graph, the results plotted using square symbols relate to the reflection from a Si substrate with a flat mirror surface, and the results plotted using inverted delta symbols each denote a reflection power when there is provided a grating structure in which the width W of an insular portion is half the grating period (basic pitch) L, i.e., a grating structure in which the ratio between the width of an insular portion and that of a groove portion is 1:1. Also, the results plotted using circular symbols each denote a reflection power when there is provided a grating structure in which the width W of an insular portion is one ninth of the grating period (basic pitch) L, and the results plotted using rhombic symbols each denote a reflection power when there is provided a grating structure in which the width W of an insular portion is one hundredth of the grating period (basic pitch) L. As is evident from the illustrated graph, as compared with the case where W/L=½, the power of reflection from the reflection portion having a grating structure increases by a factor of about three when W/L=1/9, and increases by a factor of about ten when W/L=1/100.

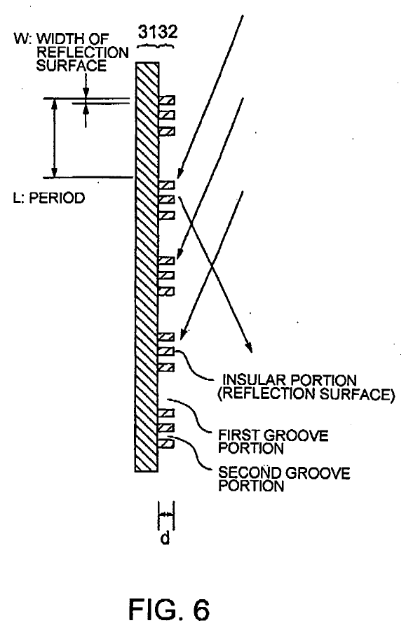

With such a grating structure provided, as seen from the de Broglie wave of incident atoms, it is necessary that the surface serving as a reflection surface looks an average surface. In other words, the de Broglie wavelength corresponding to the speed component in the normal direction to the reflection surface and the grating period must be on the same order. In order to cause the de Broglie wave of incident atoms to meet the reflection angle that does not meets such a condition, for example, it is advisable to form a plurality of insular portions in one grating period, as shown in FIG. 6. Here, the pitch between the plurality of insular portions belonging to one grating period (i.e., the sum of the width W of the insular portion and the width of a second groove portion) is a smaller pitch than the basic pitch (L) of the grating.

As described above with reference to the first to third embodiments, designing the apparent surface atomic density of the atomic reflection optical element to decrease, allows the reflection power of an atomic wave (de Broglie wave) to increase.

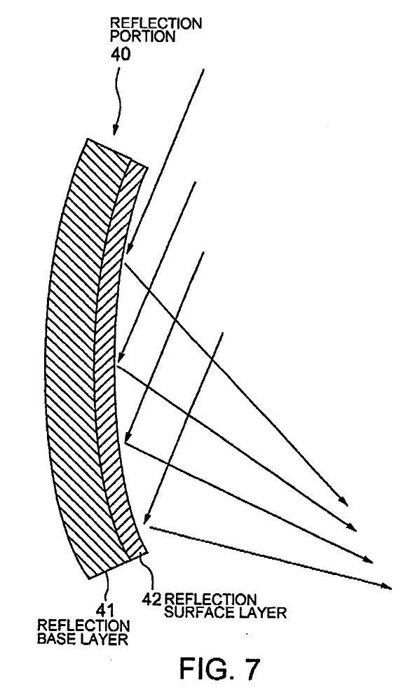

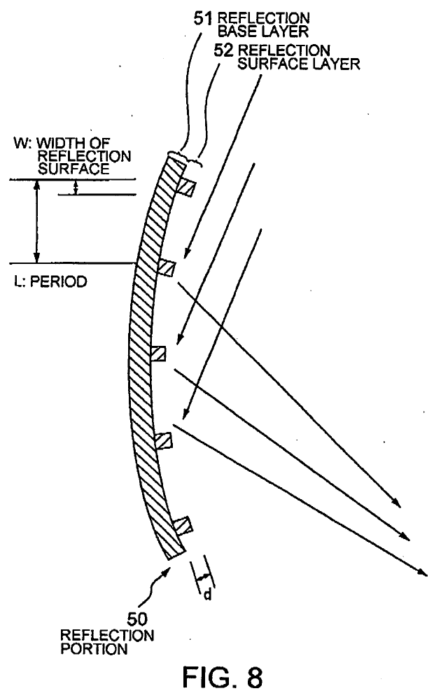

The above concept of the present invention described with reference to the first to third embodiments is effective in forming a mirror having a concave or convex surface. For example, depicted in FIG. 7 is an atomic reflection optical element having a reflection portion 40 in which a reflection surface layer 42 is formed on a reflection base layer 41 so as to have a curved-surface structure. Specifically, this is an example of a light-converging mirror in which a porous surface is formed on a concave surface, as an application of the first embodiment. Also, depicted in FIG. 8 is an atomic reflection optical element having a reflection portion 50 in which a reflection surface layer 51 acting as a curved reflection surface is formed on a reflection base layer 51. Specifically, this is an example of a cylindrical mirror formed by combining a grating and a curved reflection surface, as an application of the third embodiment. Both could provide an enhanced reflection power, as compared with the conventional simple optical reflecting mirrors.

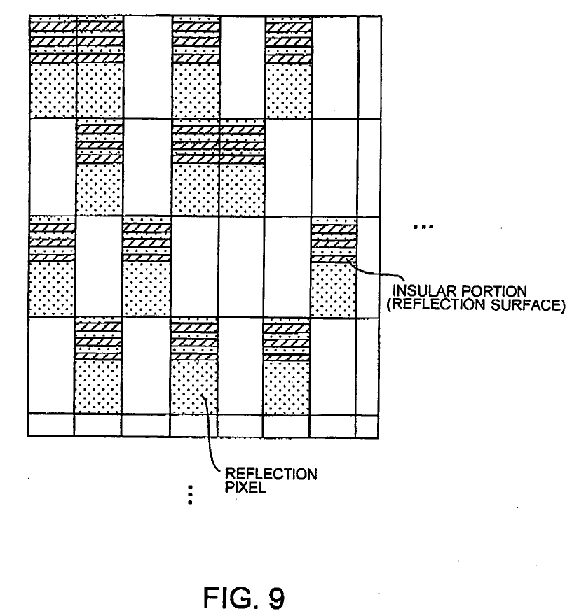

Moreover, the above-described concept of the present invention is also applicable to, for example, a reflection atomic beam hologram as shown in FIG. 9. Specifically, with respect to each pixel forming a reflection surface of a reflection atomic beam hologram designed by a computer simulation, the reflection surface is divided by a shorter period than the basic period of the hologram. The apparent atomic density of the surface of the pixel divided and reduced in this manner has become lower, resulting in an enhanced reflection power.

In the above-described embodiments, with regard to the reflection portion of the atomic reflection optical element, the atomic density has been focused on and described. However, the reflection portion may be constituted of molecules with a low molecular weight, and its reflection surface layer may be configured so as to have an effectively lower molecular density than that of the reflection base layer. Here, in order to reduce the molecular density, the above-described various techniques can be applied.

As described above, according to the present invention, by the atomic reflection optical element utilizing the quantum reflection of atomic beams, a strong atomic coherent reflection power can be achieved by reducing the effective atomic density on the reflection surface.

Industrial Applicability

The atomic reflection optical element according to the present invention can be applied to an atomic clock, atomic interferometer, gravity meter, and the like. As a result, the atomic reflection optical element according to the present invention is expected to find its application over a wide range of fields from the verification of the fundamental physical constants in the geophysics, astrophysics and the like, the formulation of theories back to the foundations of physical theories, to the aerospace engineering, next-generation electronics such as a quantum operation computer.

1. An atomic reflection optical element comprising a reflection portion for reflecting incident atoms wherein the reflection portion has a reflection base layer and a reflection surface layer disposed on the atom incident side of the reflection base layer; and wherein the element composing the reflection surface layer has an atomic density or a molecular density effectively lower than that of the reflection base layer.

2. The atomic reflection optical element according to claim 1, wherein the main direction for defining the atomic density or the molecular density is the normal direction on the surface at a point where atoms are made incident and reflected.

3. The atomic reflection optical element according to claim 1, wherein the reflection surface layer has a porous portion.

4. The atomic reflection optical element according to claim 3, wherein the size of each pore in the porous portion is smaller than the dimension of the perpendicular component of the de Broglie wavelength of incident atoms with respect to the reflection surface.

5. The atomic reflection optical element according to claim 3, wherein the porous portion comprises a porous silicon film, and wherein the reflection base layer comprises a silicon layer.

6. An atomic reflection optical element comprising a reflection portion for reflecting incident atoms wherein the reflection portion has a reflection base layer and a reflection surface layer disposed on the atom incident side of the reflection base layer, the reflection surface layer having a structure in which a thin film is supported on the reflection base layer by pillars.

7. The atomic reflection optical element according to claim 6, wherein the thin film comprises a silicon nitride film.

8. An atomic reflection optical element comprising a reflection portion for reflecting incident atoms wherein the reflection portion has a reflection base layer and a reflection surface layer disposed on the atom incident side of the reflection base layer, the reflection portion having a grating structure in which the reflection surface layer has a plurality of insular portions and groove portions formed on the reflection base layer, and the grating structure being configured so that, with respect to the grating period L thereof, the width W of each of the insular portions substantially satisfies the condition: L/10000≦W≦L/2.and.

9. (Deleted)

10. (Deleted)

11. An atomic reflection optical element comprising a reflection portion for reflecting incident atoms wherein the reflection portion has a reflection base layer and a reflection surface layer disposed on the atom incident side of the reflection base layer, the reflection portion having a grating structure in which the reflection surface layer has a plurality of insular portions and groove portions formed on the reflection base layer, and the grating structure being configured so that a plurality of insular portions are formed in one grating period.

12. The atomic reflection optical element according to claim 8 or 11, wherein each of the insular portions in the reflection surface layer and the reflection base layer comprise silicon.

13. The atomic reflection optical element according to claim 1, 8, or 11, wherein the reflection portion has a curved surface structure.

14. A holographic atomic reflection optical element comprising a reflection portion for reflecting incident atoms, wherein the reflection portion has a reflection base layer and a reflection surface layer disposed on the atom incident side of the reflection base layer, wherein the element composing the reflection surface layer has an atomic or a molecular density effectively lower than that of the reflection base layer.

15. A holographic atomic reflection optical element comprising a reflection portion for reflecting incident atoms wherein the reflection portion has a reflection base layer and a reflection surface layer disposed on the atom incident side of the reflection base layer, wherein the reflection surface layer has a structure in which a thin film is supported on the reflection base layer by pillars.
